(19) United States
(12) Patent Application Publication
(10) Pub. No.: US 2026/0195579 A1
(43) Pub. Date: Jul. 9, 2026

(54) CONSTRAINING NEURAL NETWORK PARAMETER, ACTIVATION, AND GRADIENT DYNAMIC RANGE

(71) Applicant: NVIDIA Corporation, Santa Clara, CA (US)

(72) Inventors: Matthijs Jules Van keirsbilck, Berlin (DE); Alexander Georg Keller, Berlin (DE); Nikolaus Binder, Berlin (DE); Tobias Zirr, Karlsruhe (DE); Boris Bonev, Zürich (CH)

(21) Appl. No.: 19/453,146

(22) Filed: Jan. 20, 2026

Related U.S. Application Data
(63) Continuation-in-part of application No. 19/194,372, filed on Apr. 30, 2025.
(60) Provisional application No. 63/742,231, filed on Jan. 6, 2025.
(60) Provisional application No. 63/896,391, filed on Oct. 9, 2025.

(51) Int. Cl. G06N 3/0495; G06N 3/048

(52) U.S. Cl. CPC G06N 3/0495; G06N 3/048

(57) ABSTRACT

Layer normalization within a neural network is replaced with scaling operations for stable optimization and reduced training time at a lower computational cost. The dynamic range of at least one of neural network parameters, activations, and/or gradients are constrained to a predetermined range to improve quantization and training stability without requiring calibration.

### CLAIM OF PRIORITY

This application is a continuation-in-part of U.S. patent application Ser. No. 19/194,372 (Attorney Docket No. 515255) titled “Initialization for Stable Optimization of Scaling Residual Neural Networks,” filed Apr. 30, 2025 which claims the benefit of U.S. Provisional Application No. 63/742,231 titled “GPT Without Normalization,” filed Jan. 6, 2025, the entire contents of which is incorporated herein by reference. This application also claims the benefit of U.S. Provisional Application No. 63/896,391 titled “Generative Pretrained Transformers Without Normalization,” filed Oct. 9, 2025, the entire contents of which is incorporated herein by reference.

### BACKGROUND

Conventional neural networks, for example transformers, typically perform many (computationally expensive) normalization operations, either regularly re-normalizing activations (during training and inference) or re-normalization of weight tensors after every weight update (during training). Normalizing is intended to prevent activation vanishing and explosion in deep neural networks and to stabilize gradient flow during backpropagation for faster convergence and reduced training time. However, activation normalization layers may also hinder gradient and information flow, making the optimization problem more difficult, and leading to longer training time. In addition, normalization is expensive as it leads to reduction operations, which limit computational performance especially for larger neural networks and on massively parallel processing units such as graphics processing units (GPUs). There is a need for addressing these issues and/or other issues associated with the prior art.

### BRIEF DESCRIPTION OF THE DRAWINGS

The present systems and methods of initialization for stable optimization of generative pre-trained transformers and limiting neural network parameter, activation, and gradient dynamic range are described in detail below with reference to the attached drawing figures, wherein:

FIG. 1A illustrates a block diagram of a conventional normalizing residual neural network, according to the prior art.

FIG. 1B illustrates a block diagram of an example scaling residual neural network, according to at least one embodiment.

FIG. 2A illustrates a block diagram of an example calibration configuration, according to at least one embodiment.

FIG. 2B illustrates a block diagram of an example training configuration, according to at least one embodiment.

FIG. 2C illustrates a flowchart of a method for training a residual neural network, in accordance with an embodiment.

FIG. 2D illustrates a graph comparing training a generative pre-trained transformer (GPT) with and without layer normalization, in accordance with an embodiment.

FIG. 3A illustrates a block diagram of an example range clipping residual neural network, according to at least one embodiment.

FIG. 3B illustrates a graph of piecewise soft capping activations and graphs of activation values with and without soft capping, in accordance with an embodiment.

FIG. 3C illustrates graphs of one-sided gradient masking and one-sided gradient scaling, in accordance with an embodiment.

FIG. 3D illustrates a block diagram of an example training configuration, according to at least one embodiment.

FIG. 3E illustrates a flowchart of a method for training a range clipping residual neural network, in accordance with an embodiment.

FIG. 3F illustrates a graph comparing training a generative pre-trained transformer (GPT) with layer normalization to a GPT without any normalization but with constrained weights, activations and gradients, in accordance with an embodiment.

FIG. 4 illustrates a parallel processing unit (“PPU”), according to at least one embodiment.

FIG. 5A illustrates a processing system implemented using the PPU of FIG. 4, according to at least one embodiment.

FIG. 5B illustrates an exemplary system in which the various architecture and/or functionality of the various previous embodiments may be implemented, according to at least one embodiment.

FIG. 5C illustrates components of an exemplary system that can be used to train a machine learning model, according to at least one embodiment.

FIG. 6 illustrates an exemplary streaming system, according to at least one embodiment.

### DETAILED DESCRIPTION

Systems and methods are disclosed related to initialization for stable optimization of residual neural networks, such as transformers. A residual neural network includes at least one skip connection that bypasses one or more layers or bypasses processing logic within a layer. Layer normalization is typically implemented within such neural networks to stabilize and/or accelerate training by normalizing the inputs to and/or outputs of one or more of the processing layers within the neural network. However, normalization may also hinder gradient and information flow within the neural network, making the optimization problem more difficult, and leading to longer training times. In addition, normalization is expensive as it leads to reduction operations, which limit computational performance especially for larger neural networks and on massively parallel processing units such as graphics processing units (GPUs). In the following description, ‘variance’ refers to an uncentered variance computed per token i.e. along the feature dimension. For a vector, the uncentered variance is equivalent to the squared L2 norm of the vector, divided by the number of elements. As a result, analyzing L2-norm, magnitude, or variance are equivalent. When the expected activation variance is steered towards a value of one throughout the neural network, all layers have inputs and outputs of similar magnitudes. This has been demonstrated to help optimization and may lead to improved neural network performance. In addition, any components of neural networks, such as activation functions, may be designed to operate optimally with activations having an expected variance of value one.

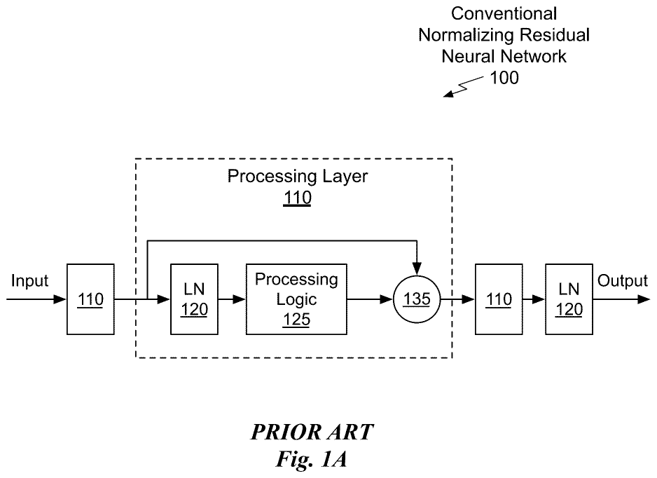

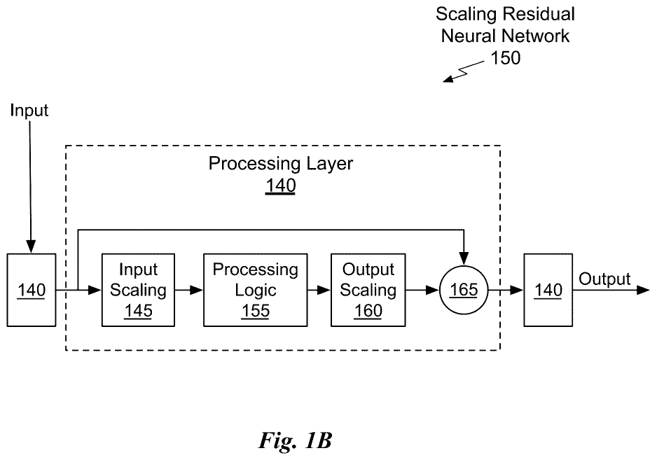

FIG. 1A illustrates a block diagram of a conventional normalizing residual neural network 100, according to the prior art. The conventional normalizing residual neural network 100 includes processing layers 110 that each include layer normalization (LN) 120 and an output is produced by a last layer normalization 120. Processing logic 125 in each processing layer 110 may include standard Attention (ATTN) and Multi-Layer-Perceptron (MLP) blocks. Consistent with many conventional neural networks, activations of the conventional normalizing residual neural network 100 do not typically have a variance equal to one throughout the entire normalizing residual neural network 100. Within each processing layer 110, a skip connection (non-processing path) from the input to the processing layer 110 is summed by an adder 135 with an output of the processing logic 125 to produce output activations. The addition 135 incorporating the skip connection is a key factor in preventing the preservation of variance. At initialization of the conventional normalizing residual neural network 100, the output of processing logic 125 is a random vector. Since the variance of the sum of independent random vectors is the sum of the variances, the adder 135 sums up the variance of the input activation 110 and the variance of the output of the processing logic 125, which increases the variance with every processing layer.

To counteract this increase in variance with every processing layer, conventional residual neural networks like GPTs typically perform many (computationally expensive) normalization operations, either regularly re-normalizing activations (during training and inference) and/or re-normalizing weight tensors after every weight update (during training). Pre-LN transformers, such as the conventional GPT 100 normalize activations at the beginning of every processing layer 110, so the sub-blocks within the processing layer 110 always see activations of similar magnitudes even if the activations on the main path increase.

As an example, for a variance-preserving processing layer 110 with a skip connection and input variance of value one, the variance after summing the skip connection with the output of the processing logic 125 by operation 135 is 1+1=2. The LN 120 reduces the variance at the input of each processing layer 110 to equal one before processing by the processing logic 125. Without layer normalization, the variance typically increases as each successive processing layer 110 processes the output activations.

In general, the skip connection adds input x to the output of processing logic, ƒ(x). As described above, the expected variance of the outputs ideally equals the expected variance of the inputs,

$${σ}_{out}^{2} = {σ}_{i n}^{2} .$$

For the conventional normalizing residual neural network 100 shown in FIG. 1A, the variance of each block is σ²(x+ƒ(x))=σ²(x)+σ²(ƒ(x)) and after L processing layers 110, the variance is σ²(xₒᵤₜ)≈(1+L)·σ²(xᵢₙ), increasing as the number of processing layers 110 increases.

Therefore, in an embodiment, layer normalization is replaced with scaling operations to achieve the benefits of layer normalization (stable optimization and reduced training time) at a lower computational cost. Scaling parameters used by the scaling operations are initialized in a way that the growth of the activation variance is bounded and then optimized during training.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

FIG. 1B illustrates a block diagram of an example scaling residual neural network 150, according to at least one embodiment. The scaling residual neural network 150 includes two or more processing layers 140 that each include input scaling 145, processing logic 155, output scaling 160, and a combining operation 165. Scaling operations performed by the input scaling 145 and output scaling 160 replace the layer normalization performed by the conventional normalizing residual neural network 100. The processing logic 155 in each processing layer 140 may include one or more input-adaptive layers such as, without limitation, attention, adaptive instance normalization, dynamic convolution, or squeeze-and-excitation blocks. In the context of the following description, an input-adaptive layer alters internal operations based on the input and therefore, an output generated in response to a particular input cannot be predicted.

In an embodiment, processing logic 155 in each processing layer 140 may include one or more Multi-Layer-Perceptron (MLP) or state space blocks. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the scaling residual neural network 150 is within the scope and spirit of embodiments of the present disclosure.

Such a residual neural network without normalization must be initialized in a way to provide stability and well-behaved activations. In an embodiment, the weights used by the processing logic 155 are initialized with a standard initialization method so that each processing layer 140 preserves the expected variance of the input and the weights, such as Glorot initialization. In another embodiment, the weights are initialized, with a standard initialization method, then the weight matrices are orthogonalized or orthonormalized. A fixed scaling may be applied to ensure activation variances are preserved.

Second, the input scaling 145 and output scaling 160 perform scaling operations on inputs to and output from the processing logic 155 using scale parameters a and (3, respectively. The scaling parameters are initialized in a way that bounds activation variance as the number of layers increases. In contrast to conventional techniques that estimate activation variance, in an embodiment, the activation variance is measured. Accurate activation variance is particularly important when the scaling residual neural network 150 includes input-adaptive layers such as attention layers commonly used in transformer-based neural networks. Activation variance for input-adaptive layers cannot be computed analytically. Yet, estimations to predict the activation variance are inaccurate, and the variance should instead be measured.

The first scale parameter β, which is applied by the output scaling 160 and scales the output of the processing logic 155 before it is accumulated with the skip path by the combining operation 165, can be used to reduce the variance to

$${σ}_{out}^{2} = {σ}_{i n}^{2} + L \cdot {β}^{2} .$$

Setting β=0 preserves the variance,

$${σ}_{out}^{2} = {σ}_{i n}^{2} .$$

Generally, β controls growth in activations for each successive processing layer 140. When stacking many layers, activations may grow exponentially if there is no additional downscaling or normalization. To avoid activation explosion, p should be initialized to a small value or zero.

Instead of normalizing activations, the second scale parameter a is applied by the input scaling 145 to the input to the processing path to counteract the growth of the activations, scaling the activations such that the variance is 1.0 (instead of performing layer normalization). As the variance grows with each successive layer and the growth is determined by β, the α for each successive processing layer 140 depends on β and decreases with depth. As the variance at the input of the l^{th} processing layer 140 is

$${σ}_{in \_ l}^{2} = {σ}_{in \_ 0}^{2} + l \cdot β ,$$

setting

$${α}^{2} = \frac{1}{{σ}_{i {n}_{0}}^{2} + l \cdot {β}^{2}}$$

scales the variance back to 1.0. In an embodiment, α and β are set to one and zero, respectively. Here

$${σ}_{in \_ l}^{2}$$

is the variance in the l-th layer, while

$${σ}_{in \_ 0}^{2}$$

is the input variance.

In another embodiment, α is set to a small value like

$$\frac{1}{l} , \frac{1}{L} ,$$

or even 0. When input-adaptive layers are not used in the scaling residual neural network 150, the variance for each processing layer 140 may be computed in advance and scale parameters can be determined that ensure each processing layer 140 processes data having similar variances.

In an example, when processing a standard benchmark, the scaling residual neural network 150 without layer normalization and the conventional normalizing residual neural network 100 with layer normalization reach losses of 3.546 and 3.544, respectively. Therefore, during training, losses are reduced to similar levels by the scaling residual neural network 150 and the conventional normalizing residual neural network 100. Although using learnable scale parameters rather than layer normalization is described in the context of GPT-style neural networks, learnable scaling may replace layer normalization in general neural networks. In one embodiment, different scale parameters may be determined for each component of a feature vector. In another embodiment, the scale parameter may be shared by all components.

Because the variance of input-adaptive processing layers cannot be determined a priori, in an embodiment, a calibration process measures variances and determines initial values for the scale parameters based on the measured variances. The scale parameters may then be learned. More specifically, an optimizer may modify the scale parameters during training.

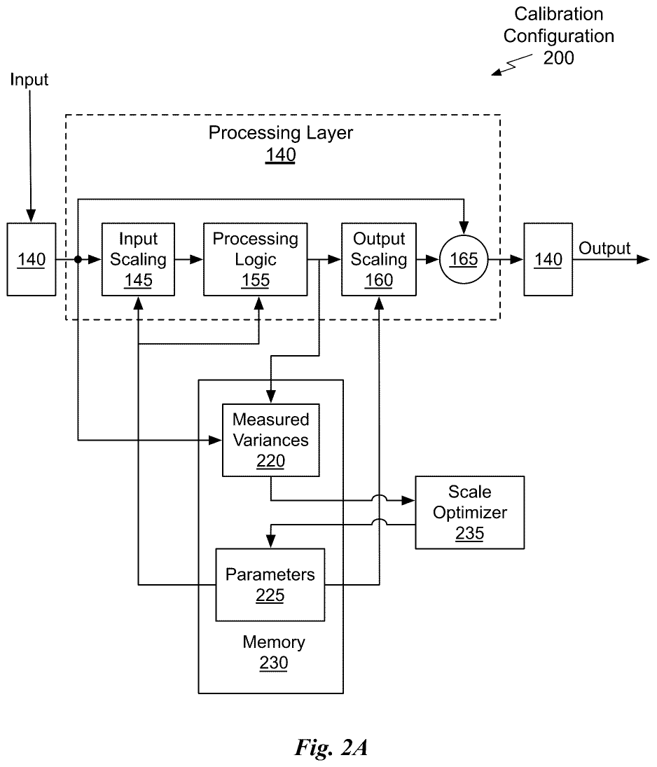

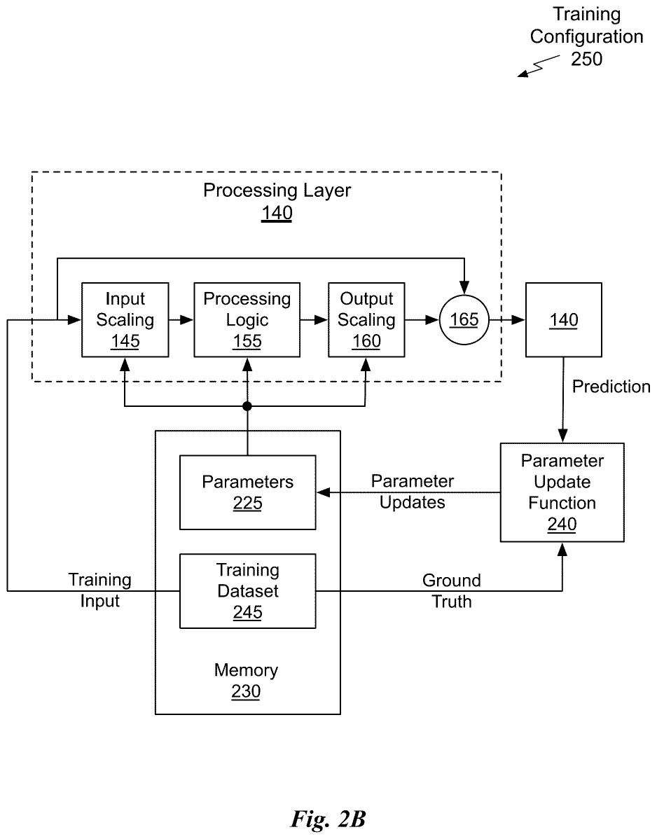

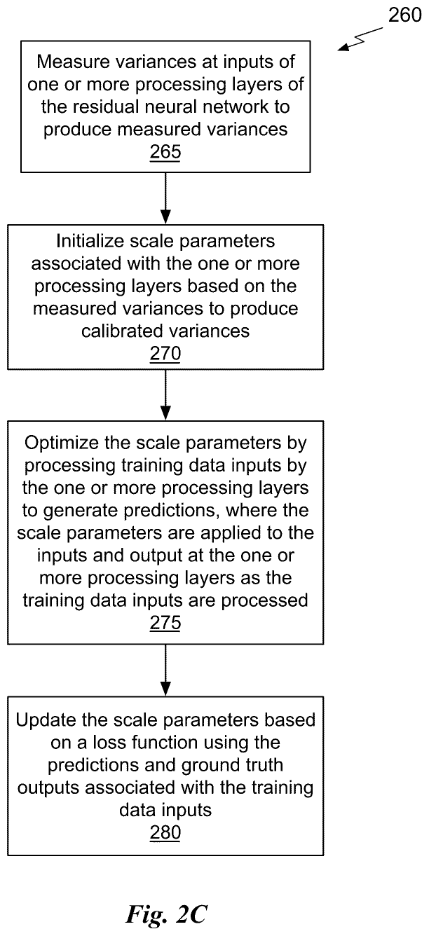

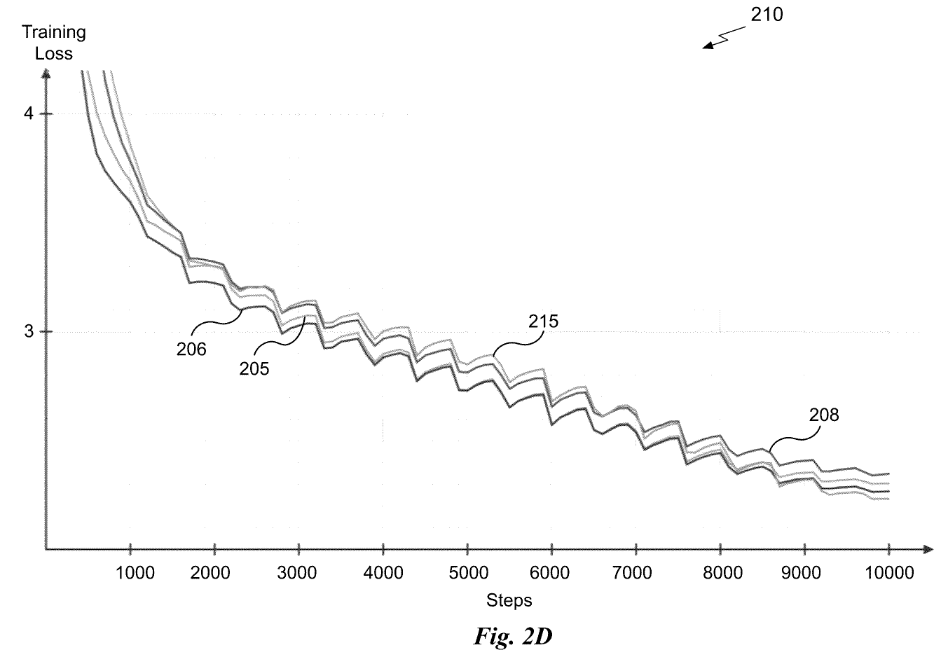

FIG. 2A illustrates a block diagram of an example calibration configuration 200, according to at least one embodiment. The calibration configuration 200 includes the scaling residual neural network 150, a scale optimizer 235, and a memory 230 that stores parameters 225 and measured variances 220. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the calibration configuration 200 is within the scope and spirit of embodiments of the present disclosure.

In an embodiment, for calibration, α and β are initialized to 1.0 and

$$\frac{1.}{\sqrt{L}} ,$$

respectively. In an embodiment, a subset of a training dataset is used during calibration to provide inputs. The inputs are processed by the processing layers 140 and, in an embodiment, variances are measured at the output of the input scaling 145 and output scaling 160. In at least one embodiment, variances are measured at one or more additional locations or fewer locations in the processing layer 140. The measured variances 220 are then used by the scale optimizer 235 to adjust the scale parameters. The parameters 225 include the scale parameters and may also include the weights used by the processing logic 155.

In an embodiment, the scale parameters are increased or decreased by the scale optimizer 235 based on the measured variances 220. For example, when the measured variances 220 are too small, the scale parameters are increased to greater than one. Conversely, when the measured variances 220 are too large, the scale parameters are decreased to less than one. After the scale parameters are adjusted, another forward pass is completed to measure the activation variance at the variance measurement locations and, if necessary, the scale parameters are adjusted. The measuring and adjusting are repeated until the measured variances are approximately equal to 1.0, completing the calibration. After the calibration process, the scale parameters can be adjusted (learned) during training. Calibration has the advantage that it doesn't require difficult analysis of the behavior of all processing layers 140 and enables data-dependent initialization to provide constant expected variance throughout the processing layers 140.

In an embodiment, after the variances are measured for a first duration (or number of inputs), the scale parameters are multiplied by

$$\sqrt{\frac{{σ}_{desired}^{2}}{{σ}_{measured}^{2}}}$$

and more inputs are processed for a second duration to measure the variances. The measuring and adjusting is repeated until the scale parameters produce the desired measured variance and optimization is complete. Although not shown in FIG. 2A, the variances can be measured at any point in the processing layers 140 within the scaling residual neural network 150 to produce a σ_{measured} at each point.

In an embodiment, the learnable scale parameters are initialized together with a fixed scaling factor in such a way that the scale optimizer 235 uses the same magnitude for all scale parameters. However, the fixed scaling factor still scales the activations up or down, equalizing the effective learning rates across all scale parameters. Similarly, in an embodiment, weight matrices are initialized by sampling from a standard normal distribution N(0,1) ensuring that the scale optimizer 235 sees the same effective learning rate for the weights at each processing layer 140 combined with fixed non-learned weight scale parameters so that the weights are variance-preserving at each processing layer 140. The scale optimizer 235 may adjust the scale parameters for variance-preservation while also controlling effective learning rates. After calibration is completed, the scale parameters are initialized for training based on the measured variances and the parameters 225 (scale parameters and weights) may be optimized during training.

At initialization, care may be taken to ensure that the variance of the activations passed to a final classification layer in the scaling residual neural network 150 is not too large. A large variance causes a peaked softmax output, which harms learning. An alternative to adding layer normalization is to introduce a learnable scale at the end of the scaling residual neural network 150 immediately before a classification layer (not shown). In an embodiment, a final learnable scale parameter is applied to the activations at the end of the scaling residual neural network 150, at the input to the classification layer. The final learnable scale is initialized to scale the variance of the final activations to a small value, e.g., 0, or

$$\frac{1}{√ L}$$

where L is the number of layers.

An analysis of the behavior of causal self-attention at initialization finds that causal self-attention behaves much like an average across a vector sequence, and that each output vector is treated differently by self-attention. Self-attention uses a softmax function which, at initialization, is strongly dependent on the scale of query (Q) and key (K) matrices with the scale parameters effectively controlling the softmax temperature. Small Q or K magnitudes cause attention to behave more like an average. When weight matrices used to compute Q and K are initialized quite small, small Q and K magnitudes and an averaging behavior result.

Due to the causal mask for self-attention, the average is different for every output vector of the attention layer. Every output vector is computed as a weighted sum over a different number of input vectors, averaging more input vectors for later output vectors (associated with later timesteps). The variance of an average of random input vectors decreases if the average is computed over more input vectors, causing different output vectors to have different variance. The variance of a weighted sum of input vectors vₜ with weights sₜ is computed as:

$${\sum }_{t = 0}^{T - 1} {s}_{t}^{2} {σ}_{{v}_{t}}^{2} .$$

With input vectors of unit variance, the variance becomes

$${\sum }_{t = 0}^{T - 1} {s}_{t}^{2} .$$

The weights sₜ sum up to one for softmax attention, the sum is always smaller than one, and the expected value decreases for larger T, i.e. for output vectors at later timesteps when the causal mask is wider. A variance of one for each output vector may be achieved by rescaling each row of an attention matrix by the expected variance of the weighted sum.

FIG. 2B illustrates a block diagram of an example training configuration 250, according to at least one embodiment. The training configuration 250 includes the scaling residual neural network 150, a parameter update function 240, and a memory 230 that stores parameters 225 and a training dataset 245. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the training configuration 250 is within the scope and spirit of embodiments of the present disclosure.

The training dataset 245 includes training inputs that are associated with ground truth outputs. The training inputs are processed by processing layers 140 within the scaling residual neural network 150 using the parameters 225 to generate predictions. The parameter update function 240 is evaluated using the ground truth outputs and the predictions to compute parameter updates. To prevent the learned scale parameters and/or weights from becoming too large and causing divergence during training, the parameter update function 240 may increase training stability by using one or more of scale and/or weight decay, weight normalization, or using clipping, or a sigmoid function to constrain the scale parameters to a predetermined range, e.g., [0,1].

In an embodiment, to reduce divergence, an L2 decay is applied to the scale parameters, providing a loss term that discourages large values. In an embodiment, magnitudes of one or more of the scaling parameters are limited by e.g. clipping or a sigmoid function, to ensure the scaling parameters constrained to a range, e.g. [0,1]. In an embodiment, weight magnitudes are directly controlled using weight normalization to normalize all weight vectors to unit L2-norm during the forward pass. Weight normalization preserves the variance of the inputs to the processing layers 140. Weight normalization tends to increase the magnitudes of the weights seen by the parameter update function 240 (even when the weights are normalized for use in the forward pass), leading to undesirable changes in effective learning rates during training (learning rate drift). In an embodiment, weight normalization is combined with weight decay to reduce learning rate drift. In an embodiment, weight magnitudes are controlled using forced weight normalization to ensure that the parameter update function 240 only sees normalized weights, thereby fixing the effective learning rate drift. If (Forced) Weight Normalization is applied to the Q/K matrices in attention layers, an additional learnable scaling operation may be included for each attention head so that the processing layer 140 can learn an optimal magnitude of the Q/K matrices. This is important as the magnitude of the inputs to the softmax function control the shape of the output, i.e., the “peakiness”. Weight normalization (forced or not) can be applied to an embedding matrix as well. When weight normalization is applied to the embedding matrix, the inputs to the scaling residual neural network 150 should be of sufficient magnitude to ensure activation functions operate in a suitable domain and avoid difficulties during training. In an embodiment, the embeddings may be scaled up or normalized in between embedding and layers within the processing logic 155. Overall, (forced) weight normalization is computationally expensive during training and therefore is not used in some embodiments.

In an embodiment, the parameter update function 240 is designed to stabilize training and control the effective learning rate. In an embodiment, the parameter update function 240 is a large batch optimization technique, such as LAMB, which adaptively rescales loss gradients leading to more stable training for large batches and higher learning rates.

In an embodiment, calibration is performed not just at initialization, but during training at specific training iterations, to ensure the activations remain in a proper range when weights are adjusted. However, applying calibrating at every training step is computationally equivalent to applying full layer normalization. Therefore, calibration may be performed only at periodic intervals or based other criteria, such as only at the beginning of training when weights change rapidly, or whenever activation variance exceeds a predefined allowed range.

FIG. 2C illustrates a flowchart of a method 260 for training a neural network, in accordance with an embodiment. Each block of method 260, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 260 is described, by way of example, with respect to the scaling residual neural network 150, calibration configuration 200, and/or training configuration 250 of FIGS. 1B, 2A, and 2B, respectively. However, this method may additionally or alternatively be executed by any one system, or any combination of systems, including, but not limited to, those described herein. Furthermore, persons of ordinary skill in the art will understand that any system that performs method 260 is within the scope and spirit of embodiments of the present disclosure.

At step 265, variances at inputs of one or more processing layers of the residual neural network are measured to produce measured variances. In an embodiment, at least one of the one or more processing layers includes an input-adaptive layer. In an embodiment, for the input-adaptive layer, weight normalization is applied to Query or Key weight matrices and learnable scales are associated with each head or channel of the input-adaptive layer. In an embodiment, at least a portion of an attention matrix associated with the input-adaptive layer are dynamically re-scaled to control an output variance for each input to the input-adaptive layer.

At step 270, scale parameters associated with the one or more processing layers are initialized based on the measured variances to produce calibrated variances. In at least one embodiment, the scale parameters comprise a first set of at least one scale parameter that is applied to the input to at least one processing logic input. In at least one embodiment, a second set of at least one scale parameter is applied to at least one processing logic output generated within the one or more processing layers. For example, a scale parameter may be applied before and/or after processing logic within a processing layer.

At step 275, the scale parameters are optimized by processing training data by the one or more processing layers to generate predictions, where the scale parameters are applied to the inputs and outputs at the one or more processing layers as the training data is processed to produce scaled layer inputs and scaled layer outputs. In an embodiment, the optimizing further comprises, based on the loss function, updating weight parameters that are applied by the one or more processing layers to the scaled layer inputs. In an embodiment, before the measuring, the first set of at least one scale parameter is initialized to one and the second set of at least one scale parameter is initialized to zero. In an embodiment, before the measuring, weight parameter tensors used by the one or more processing layers are initialized as at least one of normalized, orthogonal, or orthonormal. In an embodiment, the loss function adaptively scales gradients used to update the scale parameters.

At step 280, the scale parameters are updated based on a loss function using the predictions and ground truth outputs associated with the training data. In an embodiment, the loss function constrains an amount by which the weight parameters are updated by performing one or more of decay, normalization, forced normalization, or standardization. In an embodiment, the loss function constrains an amount by which the scale parameters are updated by performing one or more of clipping, sigmoid, and decay. In an embodiment, after processing at least a portion of the training data to optimize the scale parameters, repeating the measuring and initializing of the scale parameters.

In an embodiment, at least one of steps 265, 270, 275, or 280 is performed for training, testing, or certifying the residual neural network for deployment in a machine, robot, or autonomous vehicle. In an embodiment, at least one of steps 265, 270, 275, or 280 is performed on a virtual machine comprising a portion of a graphics processing unit. In an embodiment, at least one of steps 265, 270, 275, or 280 is implemented to include advanced error correction, fault-tolerance, and self-healing capabilities.

FIG. 2D illustrates a graph 210 comparing training a GPT with and without activation normalization, in accordance with an embodiment. Training a first GPT with activation normalization 205, such as the conventional normalizing residual neural network 100 and a second GPT training using scaling instead of activation normalization and forced weight normalization to produce training loss 215, such as the scaling residual neural network 150 reduces the training loss at similar rates. A third GPT training uses scaling with α=1 β=0, resulting in training loss 206. A fourth GPT training uses scaling and weight optimization that is scaled relative to weight norm, resulting in training loss 208.

Activation normalization within a neural network is replaced with scaling operations to achieve the benefits of activation normalization (stable optimization and reduced training time) at a lower computational cost. Scaling parameters used by the scaling operations may be initialized according to a calibration process and then learned during training (optimization). The calibration process may provide a better initialization, even and especially when the neural network includes input-adaptive layers.

### Constraining Neural Network Parameter, Activation and Gradient Dynamic Range

The dynamic range of parameters, activations, and gradients in neural networks, particularly transformer-based architectures such as GPTs, often fluctuates considerably across layers, complicating quantization and creating difficulties in deploying these models in environments with limited resources. In contrast with replacing normalization with a calibrated scaling operation, as previously described, the dynamic ranges of parameters (weights and activations) and gradients are limited or constrained to a predetermined range. Constraining the dynamic ranges may be used in addition to scaling operations. However, calibration is not required to initialize and adjust the scale parameters. Constraining the dynamic range provides an efficient and reliable method to stabilize training and enhance quantization compatibility without depending on normalization. In at least one embodiment, constraining comprises mathematical operations such as saturate, clip, clamp, bound, limit, and the like.

Specifically, normalization may be avoided by using techniques such as soft capping of activations using non-linear functions (e.g., scaled hyperbolic tangent functions) and gradient rescaling to bound weights and activations within a predetermined range. The constraining techniques may include one or more of learnable scale parameters that are initialized to control activation variance, one-sided gradient masking to constrain weight updates, and activation clipping applied at multiple points within the network (e.g., before and after skip connections). These techniques collectively ensure that activations and gradients remain well-behaved throughout training and inference. Furthermore, the described approach may eliminate the need for extensive hyperparameter tuning or calibration, easing implement across various neural network architectures. These methods ensure stable training by preventing uncontrolled growth of activations and weights, while also improving quantization by reducing outliers and maintaining a fixed dynamic range. Unlike prior approaches, the described solution achieves these benefits without requiring reduction operations, thereby reducing computational overhead and improving performance on parallel processing architectures.

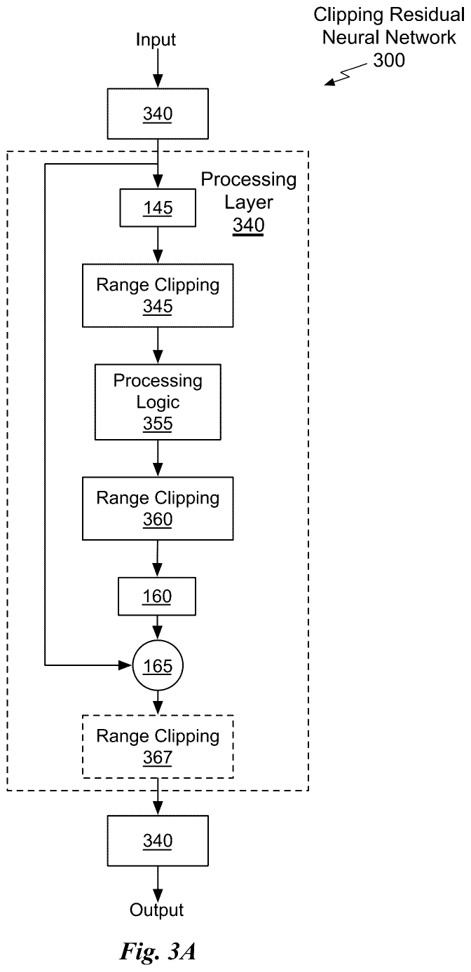

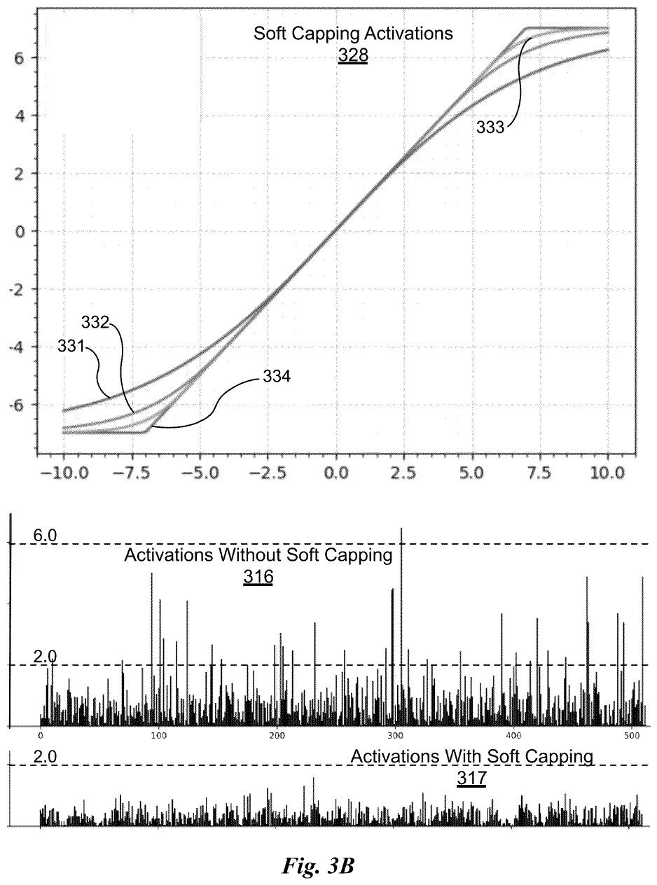

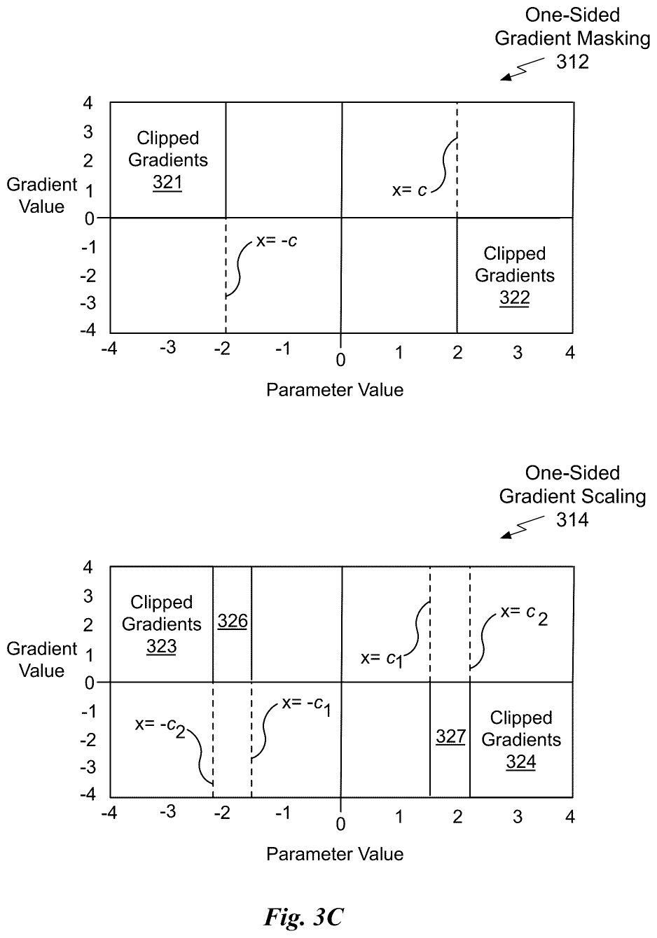

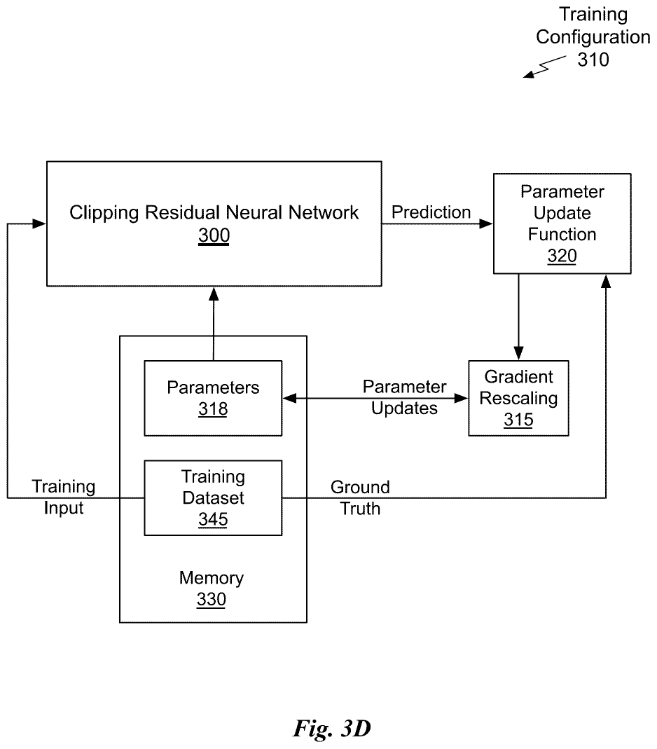

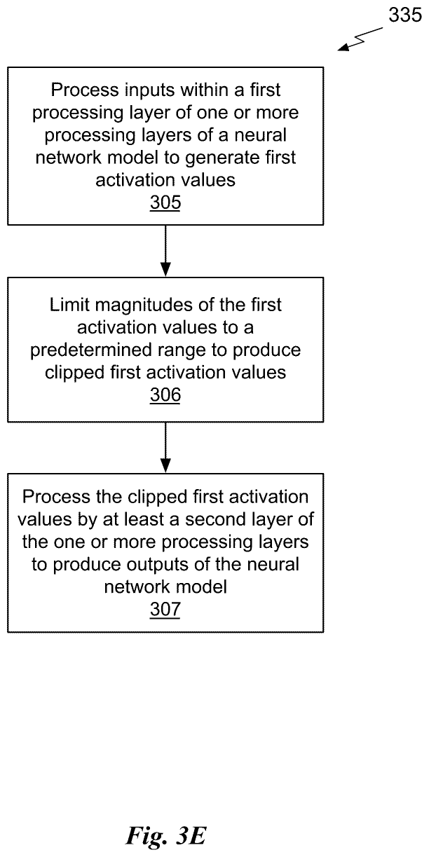

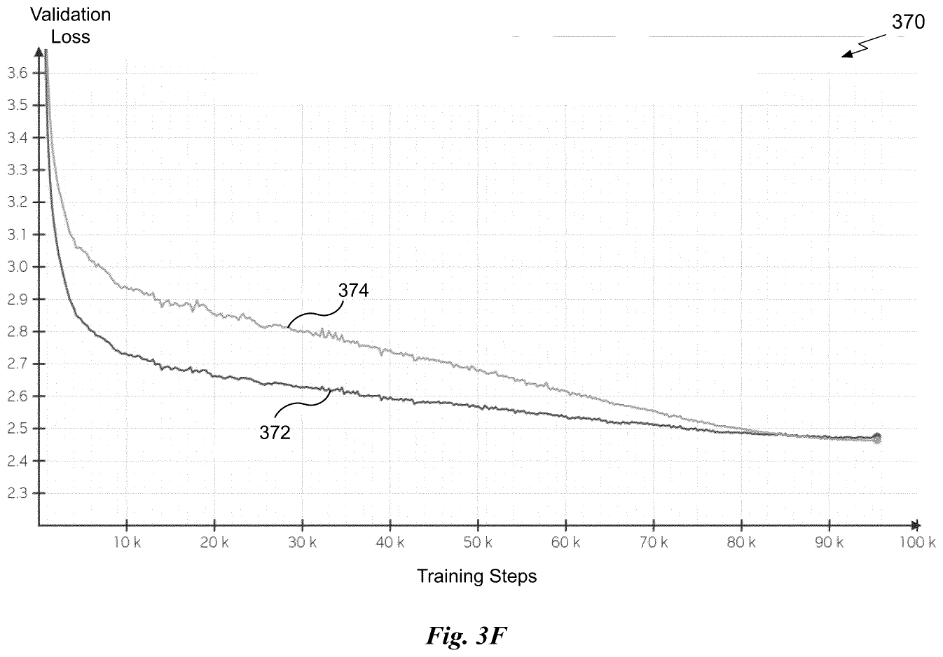

FIG. 3A illustrates a block diagram of an example range clipping residual neural network 300, according to at least one embodiment. In at least one embodiment, clipping residual neural network 300 comprises multiple processing layers 340, where each processing layer 340 may include input scaling 145, processing logic 355, output scaling 160, combining operation 165, and one or more range clipping units 345, 360, and 367 at multiple stages to constrain the dynamic range of activations to address issues such as uncontrolled activation growth and outliers, which can hinder both training stability and quantization. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of range clipping residual neural network 300 is within the scope and spirit of embodiments of the present disclosure.

As previously described in conjunction with FIG. 1B, scaling operations performed by the input scaling 145 and output scaling 160 replace the layer normalization performed by the conventional normalizing residual neural network 100. It should be understood that this and other arrangements described herein are set forth only as examples. In an embodiment, processing logic 355 in each processing layer 340 may include one or more MLP or state space blocks. Processing logic 355 in each processing layer 340 may include one or more input-adaptive layers such as, without limitation, attention, adaptive instance normalization, dynamic convolution, or squeeze-and-excitation blocks. These computations are configured to extract features from, or apply transformations to, input data. In the context of the following description, an input-adaptive layer alters internal operations based on the input and therefore, an output generated in response to a particular input cannot be predicted. As shown in FIG. 3A, range clipping 345, 360, and/or 367 may be performed after input scaling, before output scaling, and/or after the skip connection, respectively. The skip connection bypasses at least a portion of the operations performed by processing layer 340.

In an embodiment, α and β are not used directly by input scaling 145 and output scaling 160, respectively, but are instead pass through a function that constrains the value to [0,1] or [0, +inf] such as scaled sigmoid function σ_{mod}(x)=A+σ(B*(x−0.5)). In an embodiment, A=1⁻³ and B=10. In an embodiment, a and f are passed through a piecewise function e(x)={exp(x−1.0) if x<1.0 else x} to ensure the used scale is positive and scale optimizer 235 has a larger range for small values, because [−inf, 1.0] now maps to [0, 1], i.e. small values can be optimized in log space to make it easier for the optimizer to do very small adjustments. In an embodiment, learnable parameters αₗ and βₗ are constrained to 1.0 or 0.0 after the function is applied. In an embodiment, αₗ is initialized as 1.0 and βₗ is initialized as 0.001. In an embodiment, all weights and embeddings are initialized from a standard normal distribution N(0, 1). In an embodiment, each attention head has a learnable scale for queries that is initialized to 0.25. In an embodiment, each attention head has another learnable scale applied after the attention operation that is initialized to 1.0. Other techniques may be applied to further improve stability and reduce outliers. In at least one embodiment, learnable key-value tokens may be used in attention layers, which have been shown to prevent activation outliers.

Range clipping units 345, 360, and/or 367 constrain activations within a predetermined interval, thereby preventing outliers and stabilizing data supplied to subsequent a processing layer 340. In at least one embodiment, Range clipping units 345, 360, and/or 367 employ a nonlinear function, such as a scaled hyperbolic tangent, to softly cap activations using tan h logits softcapping. In at least one embodiment, clamping may be applied inside a processing layer to bound the dynamic range of intermediate activations. In at least one embodiment, an intermediate activation produced by a gated linear unit (GLU) may be clamped to ensure that the intermediate activations do not get too large. In at least one embodiment, activations at the end of the neural network are passed through a soft clamping function (tan h logits softcapping) implemented by range clipping unit 367 in a last processing layer 340 to constrain outliers before applying the softmax function.

FIG. 3B illustrates a graph of piecewise soft capping activations 328 and graphs of activation values with and without soft capping, in accordance with an embodiment. Soft capping activations 328 graph illustrates the behavior of various soft capping functions, where the x-axis represents input activation values and the y-axis represents output values after applying respective soft capping functions. Although particular functions and distributions are depicted, the number and type of functions or datasets may vary without departing from the scope of the disclosure. For example, curve 331 corresponds to standard hyperbolic tangent (tan h) function that smoothly constrains (caps) activation values within a predetermined range of approximately [−7.5, 7.5], exhibiting symmetric, non-linear saturation as inputs approach significantly positive or negative values. Note that tan h scales down nearly every activation value, not only activation values of higher magnitude. Applying tan h for range clipping activations on skip links may decay activation values.

Curve 332 represents piecewise linear-hyperbolic tangent function (tan h_lin_50), which is linear in. [−3.25, 3.25] and a scaled and shifted tan h outside of that interval to preserve a linearity of activations, thereby avoiding unnecessary scaling of most activation values, while still capping high magnitude positive and negative activation values. Curve 333 illustrates piecewise linear-tan h function (tan h_lin_75) that remains linear for 75% of the range from 0 to the maximum magnitude 7.5. Curve 334 depicts hard clipping function that abruptly limits activations to a fixed range; however, this approach may introduce discontinuities that can adversely affect gradient flow during training.

In at least one embodiment, a piecewise function is used for range clipping activation values. An example piecewise function is linear [−c₁/2, c₁/2], tan h between c₁ and c₂, and continuous in point±c₁. In one example, c₁=1.5 and c₂=2.1. Alternatively, ci can be written as K*c₂. In one example, K=0.7.

$${tanh}_{lin - c} ( x ; {c}_{1} , {c}_{2} ) = \{ \begin{matrix}x , & if \vert x \vert \leq {c}_{1} \\ ( {c}_{2} - {c}_{1} ) \cdot tanh ( \frac{x - {c}_{1}}{{c}_{2} - {c}_{1}} ) + {c}_{1} , & if x > {c}_{1} \\ ( {c}_{2} - {c}_{1} ) \cdot tanh ( \frac{x - {c}_{1}}{{c}_{2} - {c}_{1}} ) - {c}_{1} , & if x < - {c}_{1}\end{matrix}$$

Graphs 316 and 317 compare activation values with and without soft capping and activations with soft capping for one feature vector at an output of a last MLP. Activations without soft capping graph 316 shows the presence of significant outliers in the network's raw activation values, with magnitudes reaching up to 6.0 on the y-axis, plotted against activation indices on the x-axis. These outliers can destabilize training and hinder downstream quantization. Activations with soft capping graph 317 illustrates that, after applying soft capping, activation values are effectively constrained within a fixed range (e.g., [−2.1, 2.1]), thereby eliminating outliers and yielding a more uniform distribution. As a result, training stability is improved and compatibility with quantization is enhanced. Accordingly, soft capping techniques effectively constrains activation values within a predetermined range. By eliminating outliers and maintaining a controlled dynamic range, soft capping ensures stable training and facilitates quantization, making these techniques particularly beneficial for transformer-based architectures and other deep neural networks.

Applying soft capping functions to activations, as shown in FIG. 3B, effectively constrains the dynamic range of activation values during both inference and training, thereby preventing outliers and promoting stable network behavior. While this approach addresses instability and quantization challenges associated with uncontrolled activations, parameter updates via gradient backpropagation may also be constrained to remain well-behaved throughout training. By applying one-sided gradient masking and one-sided gradient scaling, the growth of parameter values may be limited, ensuring that weight updates do not lead to divergence or the emergence of outliers. This combined approach of activation soft capping and gradient range constraining provides robust control over both forward and backward passes, resulting in improved training stability and enhanced compatibility with quantization.

FIG. 3C illustrates graphs of one-sided gradient masking 312 and one-sided gradient scaling 314, in accordance with an embodiment. As shown, graph of one-sided gradient masking 312 has the parameter (weight) value on the x axis and the gradient value resulting from applying one-sided gradient masking on the y axis. In at least one embodiment, one-sided gradient masking sets a weight gradient to zero when two conditions are met. The first condition is that an absolute value of the weight is greater than a value c defining the predetermined allowed weight range (|weight|≥c). The second condition is that updating the weight using the first weight gradient will increase the magnitude of the weight (gradient>0 for negative weights and gradient<0 for positive weights). Even if the first condition is met, gradients that decrease the absolute value will not modified since reducing the absolute value could bring the weight back below the threshold. Clipped gradients 321 denote region in which a gradient is clipped to zero because the parameter value falls below a lower threshold, thereby preventing further increase in parameter's negative magnitude. Clipped gradients 322 denote region in which the gradient is clipped to zero because the parameter value exceeds an upper threshold, thereby preventing further increase in parameter's magnitude. As a result, one-sided gradient masking ensures that parameter values remain within a predefined range, avoiding outliers and maintaining stability during training.

As shown, graph of one-sided gradient scaling 314 has the parameter (weight) value on the x axis and the gradient value resulting from applying one-sided gradient masking on the y axis. Unlike masking, which fully zeroes out gradients, one-sided gradient scaling involves scaling down gradient values proportionally as corresponding parameter values approach predefined thresholds. This approach enables smoother updates while still constraining parameter values. In at least one embodiment, smooth one-sided gradient clipping at least partially downscales the weight gradient when a magnitude of the weight is greater than a first value c₁ defining a second predetermined weight range and less than a second value c₂. Scaled gradients 326 and 327 represent regions in which gradients are scaled down as they approach lower and upper thresholds, respectively, thereby ensuring gradual constraint of parameter values without abrupt changes. In other words, scaled gradients 326 and 327 define a smooth transition region for a parameter range c₂<|weight|<c₂. Clipped gradients 323 and 324 represent regions in which gradients are clipped to zero (|weight|≥c₂) to prevent further growth or reduction in parameter values.

Accordingly, one-sided gradient scaling facilitates a more gradual and controlled adjustment of parameter values, which can improve training stability and reduce risk of divergence. In summary, both one-sided gradient masking 312 and one-sided gradient scaling 314 are effective techniques for constraining parameter values within a predefined range. Whereas gradient masking 312 provides strict enforcement by zeroing out gradients, gradient scaling 314 offers a smoother approach by proportionally reducing gradient magnitudes. These methods collectively help maintain parameters in a controlled state during training, which supports stable optimization and improved compatibility with quantization.

FIG. 3D illustrates a block diagram of an example training configuration 310, according to at least one embodiment. Training configuration 310 includes clipping residual neural network 300, parameter update function 320, gradient rescaling 315, and memory 330 that stores parameters 318 and a training dataset 345. Training configuration 310 is designed to ensure stable training by constraining the dynamic range of parameters 318, activations, and gradients, thereby improving training stability and compatibility with quantization. Although various configurations may be employed, training configuration 310 provides a representative flow of data and operations involved in training clipping residual neural network 300. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the training configuration 250 is within the scope and spirit of embodiments of the present disclosure.

The training dataset 345 includes training inputs that are associated with ground truth outputs. The training inputs are processed by processing layers 340 within clipping residual neural network 300 using parameters 318 to generate predictions. Parameter update function 320 evaluates an objective function using the ground truth outputs and the predictions to compute parameter updates as gradients that are backpropagated. As a result, parameters 318 are iteratively refined to minimize the computed error. To prevent the learned scale parameters and/or weights from becoming too large and causing divergence during training, parameter update function 320 may increase training stability by using one or more of scale and/or weight decay, weight normalization, or using clipping, or a sigmoid, tan h, exponential or other function to constrain the scale parameters to a predetermined range, e.g., [0,1].

To prevent the learned weights from becoming too large and causing divergent training, training stability may be increased using gradient rescaling 315 to constrain the parameter updates and limit the dynamic range of the weights. In at least one embodiment, weight gradients (parameter updates) are scaled or masked by gradient rescaling 315 to reduce increases in magnitude for weights that already have large magnitudes. In at least one embodiment, the updated weights stored in parameters 318 are directly clipped by gradient rescaling 315 instead of or in addition to constraining the gradients that are used to update the weights.

In at least one embodiment, a soft clamping function (tan h logits softcapping) is applied to activations in a last processing layer 340 to constrain outliers before computing the loss, bounding outliers. In at least one embodiment, to ensure the activations at network input always have variance of 1, (Forced) Weight Normalization may be applied to the embedding vectors during training. In at least one embodiment, after initializing weights (from a gaussian distribution), the weight matrices are orthogonalized before starting training, while preserving the weight variance. The loss of the modified neural network resulting from weight normalization may be higher during early training than the unmodified network but generally matches or improves on the loss of the unmodified network later in training.

A property of modern optimizers like Adam and Muon may be used by parameter update function 320 to constrain the dynamic range of the gradients, making them easier to quantize. In the forward pass, a linear layer with weights of a standard Gaussian distribution may preserve the variance of the input activations by multiplying with the square root of the fan-in (the number of inputs). This can be used for initialization of the parameters (e.g. Glorot initialization). In the backwards pass, the variance of the gradients is preserved by a multiplication with fan-out instead of fan-in. For mathematic correctness, one must use the same factor in forward and backward passes but using fan-in does not preserve gradient variance, producing a large dynamic range for gradients, making the gradients difficult to quantize. However, many modern optimizers like Adam and Muon normalize gradients, meaning the scale does not matter. Therefore, fan-in may be used in the forward pass, and a different factor may be used in the backward pass, such as the fan-out (the number of outputs), without affecting training at all. In this way, gradient variance is preserved, making quantization easier. In at least one embodiment, during backpropagation of the gradients for training, the parameter update function 320 or gradient rescaling 315 multiplies the gradients with fan-out instead of fan-in to preserve the variance of the gradients and constrain the dynamic range for quantization.

Training configuration 310 ensures that clipping residual neural network 300 maintains stable training dynamics by leveraging gradient rescaling 315 and iterative parameter updates. In at least one embodiment, the system is designed to prevent outliers and uncontrolled growth in activations, weights, and gradients, which contributes to improving network performance and compatibility with quantization.

FIG. 3E illustrates a flowchart of a method 335 for training a range clipping residual neural network, in accordance with an embodiment. Each block of method 335, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 335 is described, by way of example, with respect to the clipping residual neural network 300, and/or training configuration 310 of FIGS. 3A and 3D, respectively. However, this method may additionally or alternatively be executed by any one system, or any combination of systems, including, but not limited to, those described herein. Furthermore, persons of ordinary skill in the art will understand that any system that performs method 335 is within the scope and spirit of embodiments of the present disclosure.

At step 305, inputs are processed within a first processing layer of one or more processing layers of a neural network model to generate first activation values. In at least one embodiment, magnitudes of the inputs are constrained to a predetermined range to produce bounded inputs and weights are applied to the bounded inputs to produce the first activation values. In at least one embodiment, the processing comprises applying one or more scale parameters to the inputs to produce scaled inputs and applying weights to the scaled inputs to produce the first activation values. In at least one embodiment, at least one of the one or more processing layers includes an input-adaptive layer.

At step 306, magnitudes of the first activation values are constrained to a predetermined range to produce bounded first activation values. In at least one embodiment, the magnitudes are constrained before a skip connection, within a portion of the first processing layer that is bypassed by the skip connection, and/or after the skip connection. In at least one embodiment, the predetermined range is constrained at least in part by applying a hyperbolic tangent function, a linearized tan h-like function, or a hard clipping function, such as a piecewise linear rectified linear unit (ReLU6) function that clips positive values to 6.

In at least one embodiment, processing the inputs comprises applying weights to the inputs to produce the first activation values. In at least one embodiment, before step 307, the bounded first activation values are combined with the inputs (i.e., via a skip connection). In at least one embodiment, before step 307, quantizing one or more of the bounded first activation values. In at least one embodiment, before step 307, applying one or more scale parameters to the bounded first activation values. In at least one embodiment, before step 307, a first set of at least one scale parameter is applied to the inputs and a second set of at least one scale parameter is applied to the bounded first activation values. In at least one embodiment, the first set of at least one scale parameter is initialized to either one or one divided by a square-root of an index corresponding to the first processing layer and the second set of at least one scale parameter is initialized to zero. In at least one embodiment, the second set of at least one scale parameter is initialized to a small value, such as 1⁻³.

In at least one embodiment, constraining the first activation values at step 306 comprises applying a function to scale parameters before applying the scale parameters to the first activations, where the function ensures that the scale parameters are positive and if the scale parameters are reduced that the scale parameters decrease to zero over time (e.g. sigmoid, f(x)={exp(x−1.0) if x<1.0 else x})

At step 307, the bounded first activation values are processed by at least a second layer of the one or more processing layers to produce outputs of the neural network model. In at least one embodiment, the neural network model is trained by: processing training data by applying weights at the one or more processing layers to generate predictions; computing weight gradients based on a loss function (parameter update function) using the predictions and ground truth outputs associated with the training data; constraining magnitudes of the weight gradients to a predetermined weight range to produce rescaled weight gradients; and updating the weights applied at the one or more processing layers using the rescaled weight gradients. In at least one embodiment, before the training data is processed, the weights are initialized by sampling from a Gaussian distribution or a truncated Gaussian distribution.

In at least one embodiment, a first weight gradient is set to zero when a magnitude of a first weight is greater than a value defining the predetermined weight range and updating the first weight using the first weight gradient will increase the magnitude of the first weight (i.e., one-sided gradient masking). In at least one embodiment, when a magnitude of a first weight is greater than a second value defining a second predetermined weight range and less than the first value, the first weight gradient is at least partially downscaled to update the first weight (i.e., smooth one-sided gradient clipping). In at least one embodiment, at least one of activations, weights, gradients are quantized during training. In at least one embodiment, during backpropagation of the gradients for training, the gradients are multiplied with fan-out instead of fan-in to preserve the variance of the gradients and constrain the dynamic range for quantization. In at least one embodiment, at least one of steps 305, 306, or 307 is implemented to include advanced error correction, fault-tolerance, or self-healing capabilities.

FIG. 3F illustrates a graph 370 comparing training a generative pre-trained transformer (GPT) with and without layer normalization, in accordance with an embodiment. The x-axis is training steps and the y-axis is validation loss. Curve 372 is the validation loss for a standard GPT with layer normalization. Curve 374 is the validation loss for a GPT without any normalization and with scaling and range clipping, such as range clipping residual neural network 300. The validation loss is reduced to a similar final loss for the GPT with range clipping compared with the GPT with layer normalization.

A robust and efficient alternative to normalization-based approaches in transformer-based neural networks constrains the dynamic range of parameters, activations, and gradients using element-wise operations such as soft capping and gradient rescaling. This eliminates the need for computationally expensive reduction operations, improves training stability, prevents outliers, and ensures consistent dynamic ranges across layers, thereby facilitating quantization and deployment on parallel processing hardware. Furthermore, hyperparameter tuning or calibration may be avoided, resulting in a scalable, quantization-friendly, and high-performance solution for both training and inference.

In some examples, the model(s) (e.g., machine learning models, deep neural networks, language models, LLMs, VLMs, multi-modal language models, perception models, tracking models, fusion models, transformer models, diffusion models, encoder-only models, decoder-only models, encoder-decoder models, neural radiance field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure.

For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Additionally, in some embodiments, the systems and methods described herein may be performed within a simulation environment (e.g., NVIDIA's DriveSIM, ISAAC GYM, and/or ISAAC SIM) using simulated data (e.g., simulated sensor data of simulated sensors of a virtual or simulated machine). For example, simulated sensor data and/or map data (simulated or real) may be used to perform various operations within the simulation environment, such as to generate the simulation data and/or operate a machine. These simulated operations may be used to test performance of the underlying algorithms, systems, image processing pipelines, and/or processes prior to deploying them in the real-world. In some instances, the simulation may be used to generate synthetic training data—e.g., training data including landmarks, features, objects, etc.—so that the synthetic training data (in addition to or alternatively from real-world data) may then be processed to perform one or more of the operations described herein.

In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural radiance field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### Parallel Processing Architecture

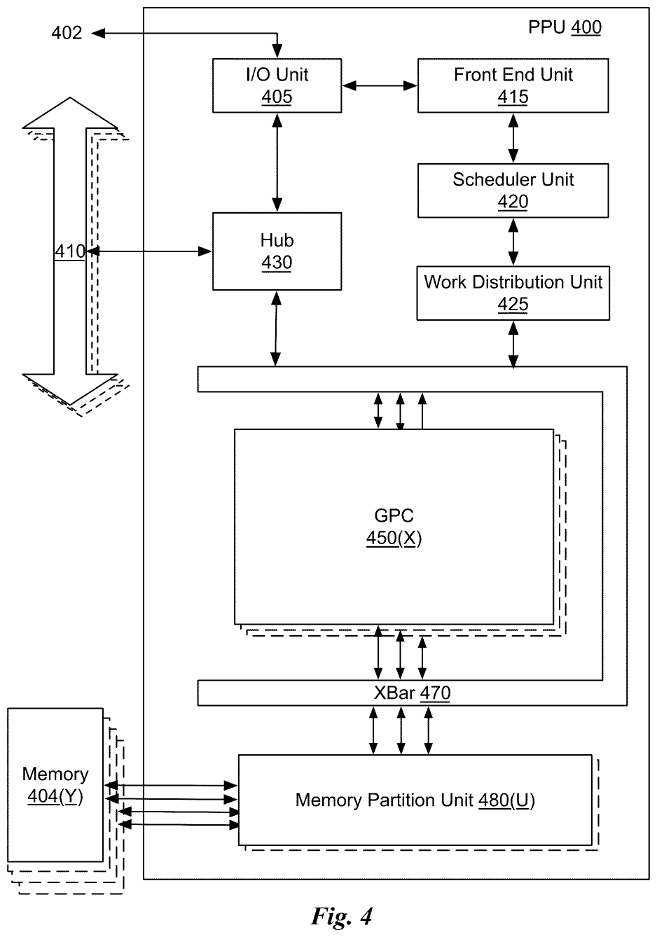

FIG. 4 illustrates a parallel processing unit (PPU) 400, in accordance with an embodiment. The PPU 400 may be used to implement the GPT 150, the calibration configuration 200, and/or the training configuration 250. The PPU 400 may be used to implement one or more of the processing layers 140, scale optimizer 235, and/or parameter update function 240. The PPU 400 may be used to implement the range clipping 345, 360, and/or 367, clipping residual neural network 300 and/or the training configuration 310. In an embodiment, a processor such as the PPU 400 may be configured to implement a neural network model. The neural network model may be implemented as software instructions executed by the processor or, in other embodiments, the processor can include a matrix of hardware elements configured to process a set of inputs (e.g., electrical signals representing values) to generate a set of outputs, which can represent activations of the neural network model. In yet other embodiments, the neural network model can be implemented as a combination of software instructions and processing performed by a matrix of hardware elements. Implementing the neural network model can include determining a set of parameters for the neural network model through, e.g., supervised or unsupervised training of the neural network model as well as, or in the alternative, performing inference using the set of parameters to process novel sets of inputs.

In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

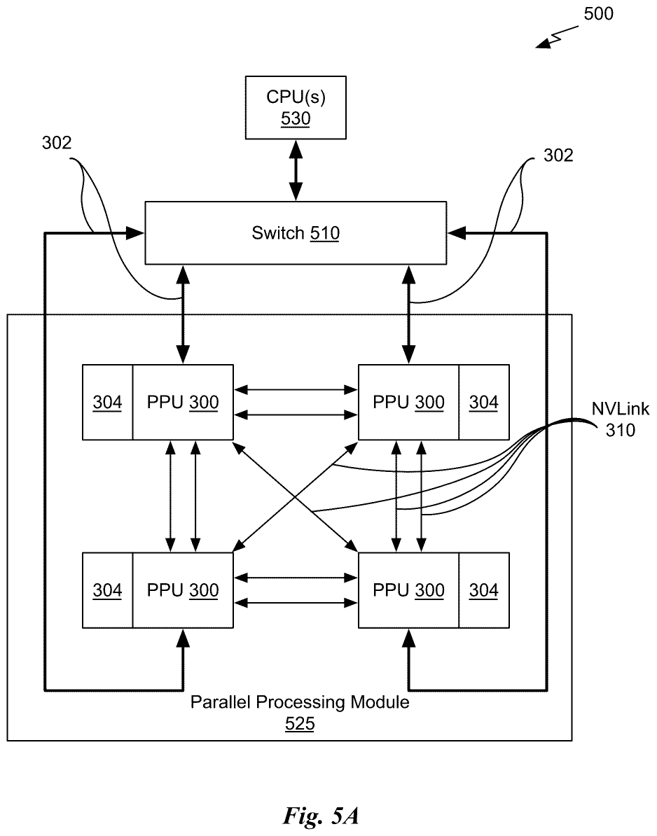

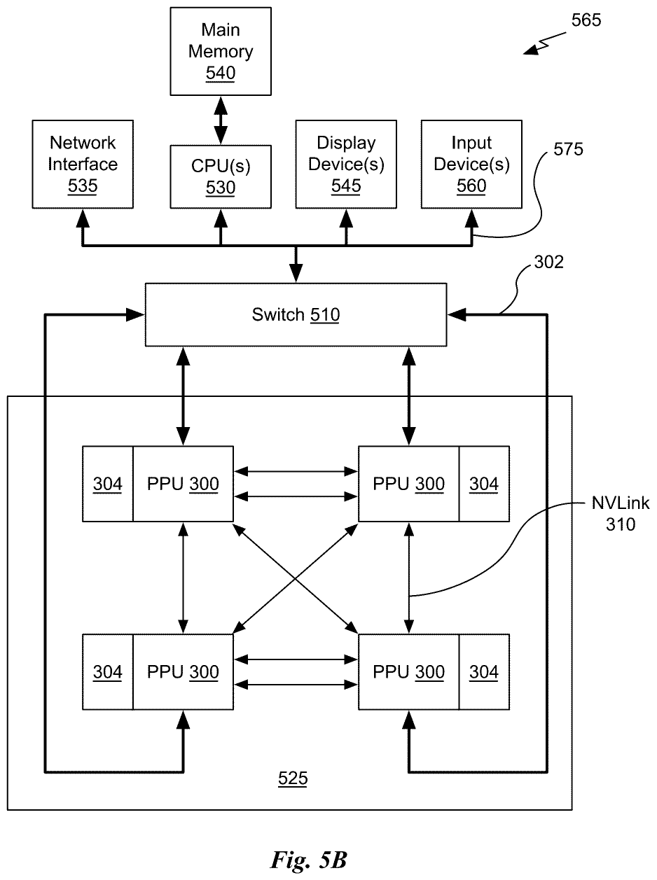

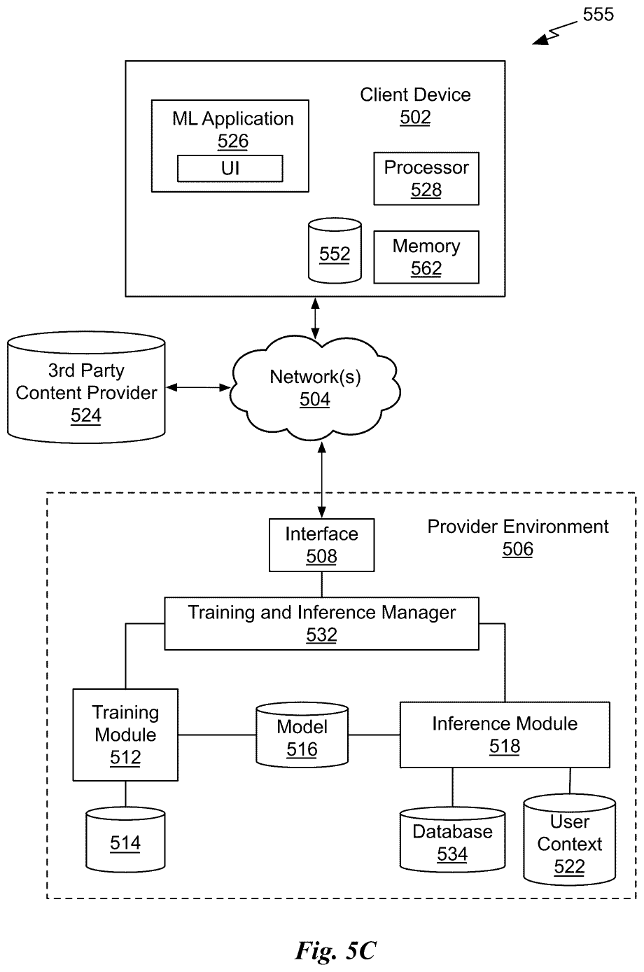

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QoS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in an L2 cache, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The exemplary system 500 may be configured to implement the method 260 shown in FIG. 2C and/or method 335 shown in FIG. 3E. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented. The exemplary system 565 may be configured to implement the method 260 shown in FIG. 2C and/or method 335 shown in FIG. 3E.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5B are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5B is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5B.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5A and/or exemplary system 565 of FIG. 5B. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In an embodiment, the set of training data may be used in a generative adversarial training configuration to train a generator neural network. In at least one embodiment, training data can include images of at least one human subject, avatar, or character for which a neural network is to be trained. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The graphics processing pipeline may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the PPU 400. The API provides an abstraction for a programmer that lets a programmer utilize specialized graphics hardware, such as the PPU 400, to generate the graphical data without requiring the programmer to utilize the specific instruction set for the PPU 400. The application may include an API call that is routed to the device driver for the PPU 400. The device driver interprets the API call and performs various operations to respond to the API call. In some instances, the device driver may perform operations by executing instructions on the CPU. In other instances, the device driver may perform operations, at least in part, by launching operations on the PPU 400 utilizing an input/output interface between the CPU and the PPU 400. In an embodiment, the device driver is configured to implement the graphics processing pipeline 600 utilizing the hardware of the PPU 400.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA GeForce Now (GFN), Google Stadia, and the like.

### Example Streaming System

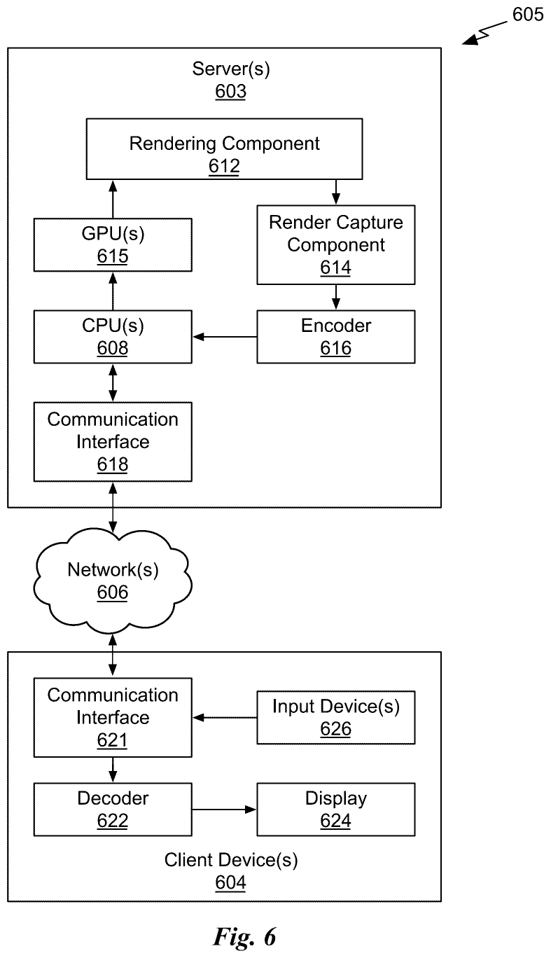

FIG. 6 is an example system diagram for a streaming system 605, in accordance with some embodiments of the present disclosure. FIG. 6 includes server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

In at least one embodiment, one or more techniques described herein utilize a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model utilizes a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oneAPI and/or oneAPI programming model is utilized to interact with various accelerator, GPU, processor, and/or variations thereof, architectures. In at least one embodiment, oneAPI includes a set of libraries that implement various functionalities. In at least one embodiment, oneAPI includes at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is utilized for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as oneVPL, is a library that is utilized for accelerating video processing in one or more applications. In at least one embodiment, oneVPL implements various video decoding, encoding, and processing functions. In at least one embodiment, oneVPL implements various functions for media pipelines on CPUs, GPUs, and other accelerators. In at least one embodiment, oneVPL implements device discovery and selection in media centric and video analytics workloads. In at least one embodiment, oneVPL implements API primitives for zero-copy buffer sharing.

In at least one embodiment, a oneAPI programming model utilizes a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

In at least one embodiment, any application programming interface (API) described herein is compiled into one or more instructions, operations, or any other signal by a compiler, interpreter, or other software tool. In at least one embodiment, compilation comprises generating one or more machine-executable instructions, operations, or other signals from source code. In at least one embodiment, an API compiled into one or more instructions, operations, or other signals, when performed, causes one or more processors such as graphics processors @22@00, graphics cores @12@00, parallel processor @14@00, processor @17@00, processor core @17@00, or any other logic circuit further described herein to perform one or more computing operations.

It should be noted that, while example embodiments described herein may relate to a CUDA programming model, techniques described herein can be utilized with any suitable programming model, such HIP, oneAPI, and/or variations thereof.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method for training a residual neural network, comprising:
processing inputs within a first processing layer of one or more processing layers of a neural network model to generate first activation values;
constraining magnitudes of the first activation values to a predetermined range to produce bounded first activation values; and
processing the bounded first activation values by at least a second layer of the one or more processing layers to produce outputs of the neural network model.

2. The method of claim 1, wherein the predetermined range is constrained by applying a non-linear function.

3. The method of claim 1, wherein the predetermined range is constrained at least in part by applying a hyperbolic tangent function, a linearized tan h-like function, or a hard clipping function.

4. The method of claim 1, wherein processing the inputs comprises applying weights to the inputs to produce the first activation values.

5. The method of claim 1, further comprising, before processing the bounded first activation values, optionally combining the bounded first activation values with the inputs.

6. The method of claim 1, wherein processing the inputs comprises:
constraining magnitudes of the inputs to the predetermined range to produce bounded inputs; and
applying weights to the bounded inputs to produce the first activation values.

7. The method of claim 1, further comprising training the neural network model by:
processing training data by applying weights at the one or more processing layers to generate predictions;
computing weight gradients based on a loss function using the predictions and ground truth outputs associated with the training data;
constraining magnitudes of the weight gradients to a predetermined weight range to produce rescaled weight gradients; and
updating the weights applied at the one or more processing layers using the rescaled weight gradients.

8. The method of claim 7, further comprising, before processing the training data, initializing the weights by sampling from a Gaussian distribution or a truncated Gaussian distribution.

9. The method of claim 7, wherein a first weight gradient is set to zero when a magnitude of a first weight is greater than a value defining the predetermined weight range and updating the first weight using the first weight gradient will increase the magnitude of the first weight.

10. The method of claim 7, wherein when a magnitude of a first weight is greater than a second value defining a second predetermined weight range and less than the first value, the first weight gradient is at least partially downscaled to update the first weight.

11. The method of claim 1, further comprising quantizing one or more of the bounded first activation values before processing the bounded first activation values by the second layer.

12. The method of claim 1, wherein processing the inputs comprises:
applying one or more scale parameters to the inputs to produce scaled inputs; and
applying weights to the scaled inputs to produce the first activation values.

13. The method of claim 1, further comprising applying one or more scale parameters to the bounded first activation values before processing the bounded first activation values by at least the second layer.

14. The method of claim 1, wherein a first set of at least one scale parameter is applied to the inputs and a second set of at least one scale parameter is applied to the bounded first activation values before processing the bounded first activation values by at least the second layer.

15. The method of claim 14, further comprising, initializing the first set of at least one scale parameter to either one or one divided by a square-root of an index corresponding to the first processing layer and initializing the second set of at least one scale parameter to zero.

16. The method of claim 1, where constraining the first activation values comprises applying a function to scale parameters before applying the scale parameters to the first activations, wherein the function ensures that the scale parameters are positive and if the scale parameters are reduced that the scale parameters gradually to zero over time.

17. The method of claim 1, wherein at least one of the one or more processing layers includes an input-adaptive layer.

18. The method of claim 1, wherein at least one of activations, weights, gradients are quantized during training.

19. The method of claim 1, wherein at least one of the steps of the processing of inputs, the constraining, or the processing of the bounded first activation values is performed for training, testing, or certifying the residual neural network for deployment in a machine, robot, or autonomous vehicle.

20. The method of claim 1, wherein at least one of the steps of the processing of inputs, the constraining, or the processing of the bounded first activation values is performed on a virtual machine comprising a portion of a graphics processing unit.

21. The method of claim 1, wherein at least one of: the processing of inputs, the constraining, or the processing of the bounded first activation values is implemented to include advanced error correction, fault-tolerance, or self-healing capabilities.

22. The method of claim 1, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of extended reality content, augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more language reasoning models (LRMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system implemented at least partially in a data center;
a system implemented at least partially using cloud computing resources;
a system using or deploying one or more inference microservices;
a system that incorporates one or more machine learning models deployed in a service or microservice along with an OS-level virtualization package (e.g., a container).

23. A system, comprising:
a memory that stores inputs for a neural network model; and
a processor that is connected to the memory, wherein the processor is configured to implement the neural network by:
processing inputs within a first processing layer of one or more processing layers of the neural network model to generate first activation values;
constraining magnitudes of the first activation values to a predetermined range to produce bounded first activation values; and
processing the bounded first activation values by at least a second layer of the one or more processing layers to produce outputs of the neural network model.

24. The system of claim 23, wherein, processing the inputs comprises applying weights to the inputs to produce the first activation values.

25. The system of claim 23, further comprising, before processing the bounded first activation values, optionally combining the bounded first activation values with the inputs.

26. The system of claim 23, wherein processing the inputs comprises:
constraining magnitudes of the inputs to the predetermined range to produce bounded inputs; and
applying weights to the bounded inputs to produce the first activation values.

27. The system of claim 23, wherein system comprises at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of extended reality content, augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more language reasoning models (LRMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system implemented at least partially in a data center;
a system implemented at least partially using cloud computing resources;
a system using or deploying one or more inference microservices;
a system that incorporates one or more machine learning models deployed in a service or microservice along with an OS-level virtualization package (e.g., a container).

28. A non-transitory computer-readable medium storing computer instructions that, when executed by one or more processors, cause the one or more processors to perform the steps of:
processing inputs within a first processing layer of one or more processing layers of a neural network model to generate first activation values;
constraining magnitudes of the first activation values to a predetermined range to produce bounded first activation values; and
processing the bounded first activation values by at least a second layer of the one or more processing layers to produce outputs of the neural network model.

29. The non-transitory computer-readable media of claim 28, wherein the predetermined range is prescribed by applying a non-linear function.
